(19) United States
(12) Patent Application Publication
(10) Pub. No.: US 2025/0362527 A1
(43) Pub. Date: Nov. 27, 2025

(54) FRAME FOR EYEGLASSES WITH NOSE PAD

(71) Applicant: LUXOTTICA S.R.L., AGORDO (IT)

(72) Inventor: Giovanni PARRA MARCHETTI, ROMA (IT)

(21) Appl. No.: 18/872,670

(22) PCT Filed: Jun. 5, 2023
(86) PCT No.: PCT/IB2023/055764

§ 371 Date: Dec. 6, 2024

(30) Foreign Application Priority Data
Jun. 8, 2022 (IT) 102022000012086

(51) Int. Cl. G02C 5/12

(52) U.S. Cl. CPC G02C 5/126

(57) ABSTRACT

A frame for eyeglasses with nose pads, which comprises frame portions adapted to accommodate a pair of lenses, each frame portion adapted to accommodate a respective lens being provided with a seat which is adapted to accommodate a nose pad.

The present invention relates to a frame for eyeglasses with nose pads. More specifically, the present invention relates to a frame for eyeglasses with nose pads that are substantially concealed behind the frame.

As is known, the frames of eyeglasses are provided with nose pads that make it possible for the frames to be placed on the nose of the user. The nose pads are shaped in different ways, and their importance is evident for the comfort of fit of the frame.

It often happens in fact that nose pads that are too hard cause discomfort for the user, who, after wearing the frame for some time, feels the need to remove it from his or her face.

Furthermore, nose pads are also important elements in the appearance of the frame. In fact, they are elements that protrude from the frame, from behind it, i.e., directed toward the face of the user, but are still visible from the front, and therefore their appearance is a very important factor in the attractiveness that a frame can elicit in the user at the moment of purchase.

Furthermore, the nose pads can be made of different materials, more or less soft or more or less hard, but in both cases their presence paired with a frame renders that frame aesthetically much less “slender” than it could be in their absence.

It is however clear that the nose pads must be present, for it to be possible to place the frame on the nose of the user, and therefore there is an unceasing search for solutions that can offer comfort to the user and at the same time render the nose pads aesthetically more pleasing.

The aim of the present invention is to provide a frame for eyeglasses with nose pads, in which the nose pads can be substantially hidden from the bulk of the frame.

Within this aim, an object of the present invention is to provide a frame for eyeglasses in which the nose pads have dimensions of space occupation that are such as to be substantially invisible with respect to the rest of the frame.

Another object of the present invention is to provide a frame for eyeglasses in which the nose pads are utterly comfortable for the user, and do not therefore constitute a hard point of contact on the nose of the user.

Another object of the present invention is to provide a frame for eyeglasses with nose pads that is highly reliable, easily and practically implemented and low cost.

This aim and these and other objects which will become better apparent hereinafter are achieved by a frame for eyeglasses with nose pads, which comprises a frame adapted to accommodate a pair of lenses, characterized in that each frame portion adapted to accommodate a respective lens is provided with a seat which is adapted to accommodate a nose pad.

Further characteristics and advantages of the invention will become better apparent from the description of preferred, but not exclusive, embodiments of the frame for eyeglasses according to the present invention, which are illustrated by way of non-limiting example in the accompanying drawings, wherein:

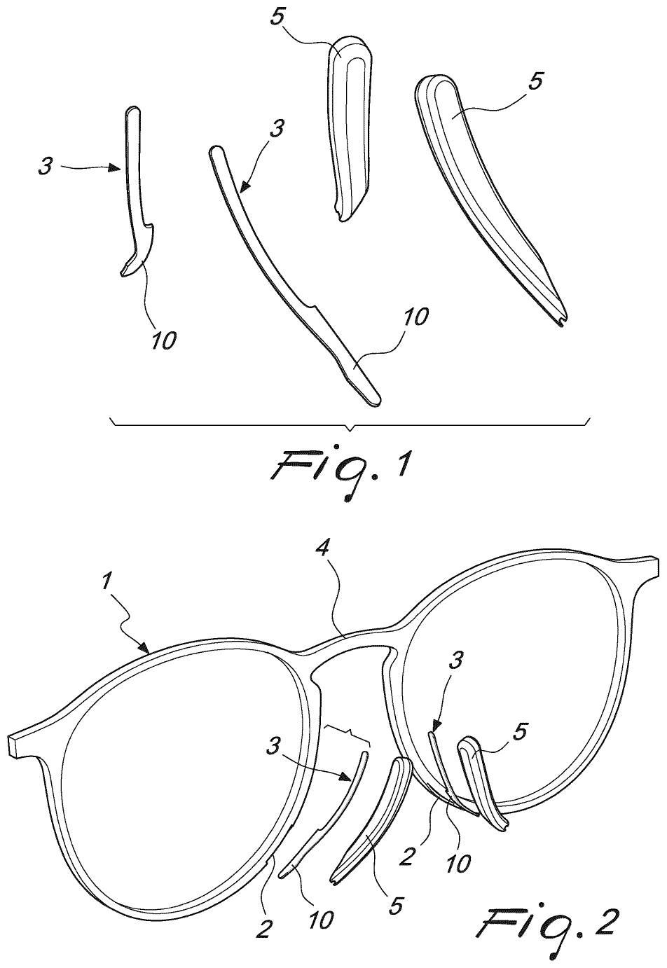

FIG. 1 is an exploded perspective view of a pair of nose pads according to the present invention, according to a first embodiment;

FIG. 2 is an exploded perspective view from the rear of a frame and an associated pair of nose pads according to the present invention, according to the first embodiment;

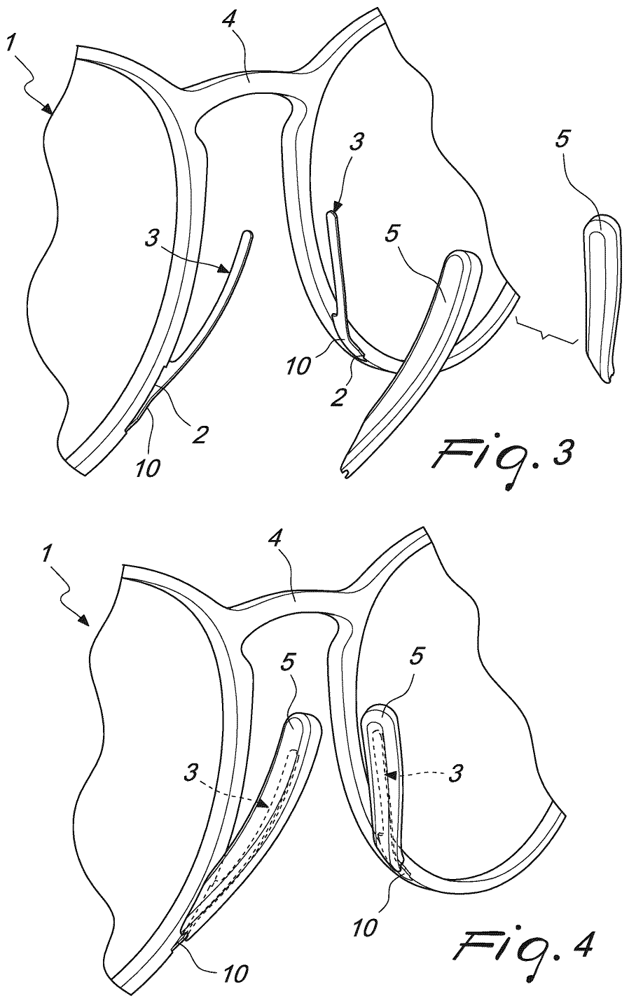

FIG. 3 is a partial, and partially exploded, perspective view from the rear of the frame according to the present invention, with the nose pads mounted and the coverings of the nose pads removed, according to the first embodiment;

FIG. 4 is a partial perspective view from the rear of the frame according to the present invention with the nose pads mounted, according to the first embodiment;

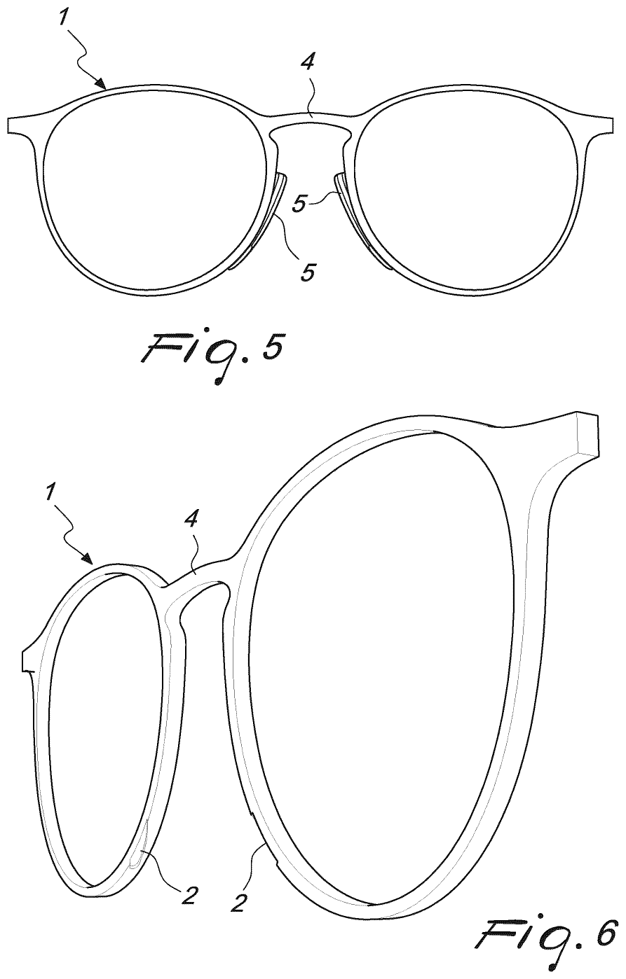

FIG. 5 is a front elevation view of the frame according to the present invention, according to the first embodiment;

FIG. 6 is a perspective view of the frame of FIGS. 1-5 with the nose pads removed;

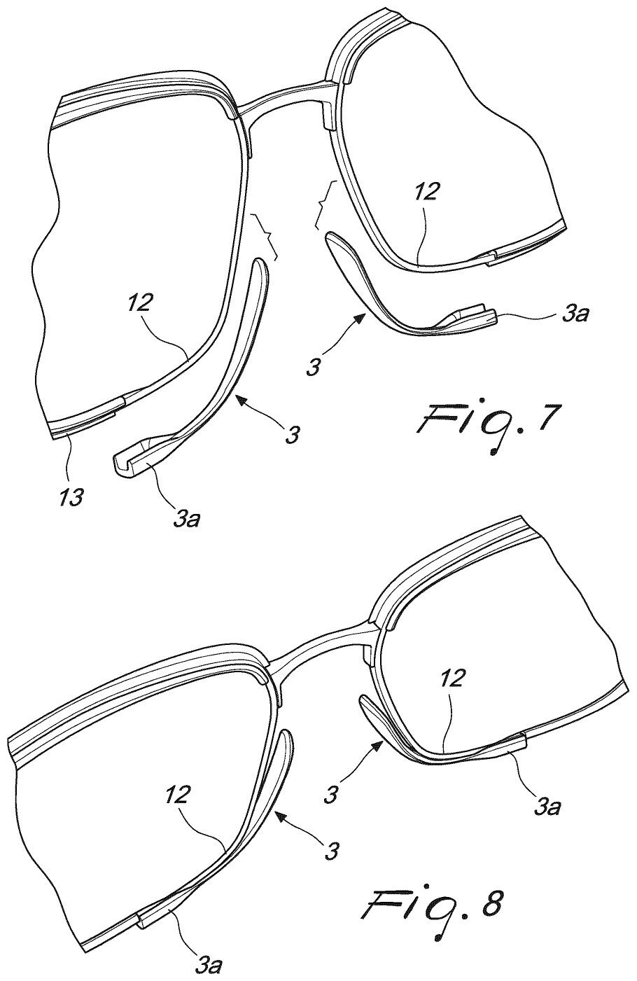

FIG. 7 is an exploded perspective view of a second embodiment of the frame according to the present invention;

FIG. 8 is a perspective view of the second embodiment of the frame according to the present invention;

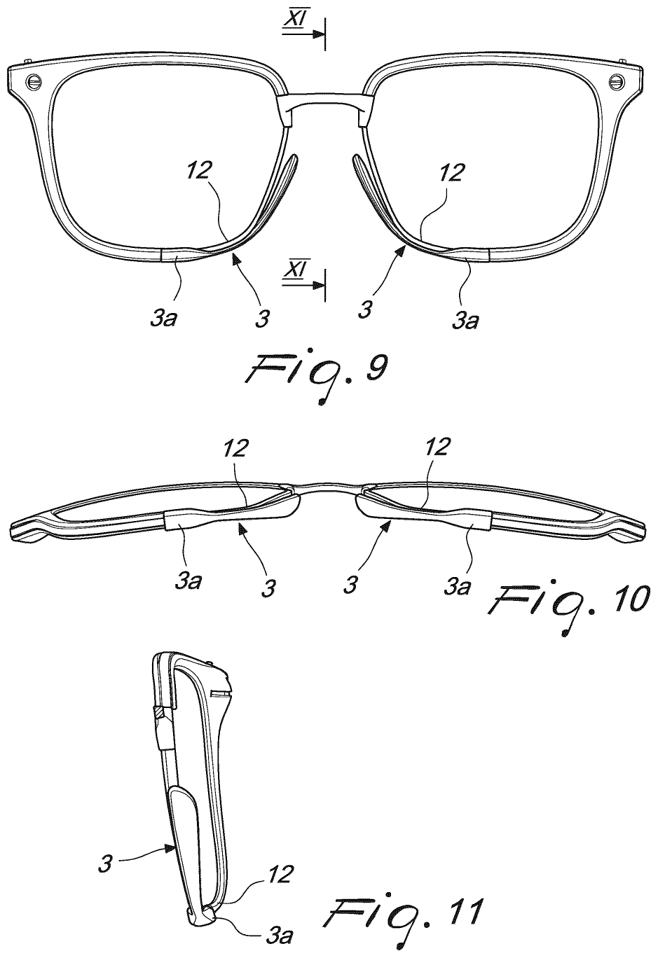

FIG. 9 is a front elevation view of the frame according to the present invention, according to the second embodiment;

FIG. 10 is a view from below of the frame according to the present invention, according to the second embodiment;

FIG. 11 is a transverse cross-sectional view, taken along the plane XI-XI of FIG. 9, of the frame according to the present invention.

With reference to the figures, the frame for eyeglasses according to the present invention, generally designated by the reference numeral 1, comprises a frame characterized in that, at each frame portion adapted to accommodate the lens, and specifically at a region of the frame that faces the region for holding the opposing lens, it has a seat 2, which takes the form of a recess or more generally a reduction in the profile of the frame 1, such as to accommodate a nose pad 3, which is conveniently shaped, with its own distal end portion (“distal” means the end of the nose pad furthest from the eye of the user), so as to be complementary to the seat 2 of the frame 1.

So the nose pad 3 extends upward from the seat 2 and the only engagement region of the nose pad 3 is constituted by its distal end portion 10.

More specifically, the seat 2 is shaped, for example, as shown in the figures, like a droplet, with a depth that decreases moving upward from below, i.e., the portion of seat 2 arranged furthest from the bridge 4 of the frame 1 has a greater depth than the portion of seat 2 that is arranged closest to the bridge 4 of the frame 1.

Conveniently, the nose pad 3, meaning one nose pad 3 for each one of the two frame portions that accommodate the respective lenses, is made of metallic material, in this manner being elastically yielding, flexible.

The nose pad 3 is conveniently soldered at the seat 2 defined above, and therefore extends upward from below, i.e. from the frame portion furthest from the bridge 4 of the frame 1, toward the bridge 4.

The soldering of the nose pad is done by soldering the distal end portion of the nose pad which is adapted to be accommodated in the seat 2.

The nose pad 3 can also be coupled in the seat 2 using adhesive bonding or the like.

Conveniently, the nose pad 3 is substantially rod-like.

The shape of the seat 2 of the nose pad 3 makes it possible for the nose pad to be substantially concealed behind the curved part of the frame portion 1 that accommodates the respective lenses, especially when the frame is being worn and the nose pads bend in contact with the nose of the user.

In fact, not only is the nose pad 3 coupled, by soldering (or the like) in the seat 2, but it is also conveniently curved with a curvature substantially similar to the curvature of the frame 1 so that the nose pad 3 is substantially concealed by superimposition with the frame portion that accommodates the respective lens.

On the one hand, it is possible to have a nose pad 3 that is extremely flexible, being made of metallic material and therefore intrinsically elastic, and on the other hand, it is possible to have the nose pad 3 substantially completely concealed behind the frame 1, so that when the user places the eyeglasses on his or her nose, an onlooker sees the frame 1 substantially “floating” on the nose of the user, in that the nose pad 3 disappears behind the frame, when the frame is seen from the front.

This offers not only exceptional comfort of wear for the user, but also an attractive appearance for the frame, which appears as though it completely lacks nose pads.

Conveniently, the nose pads 3 can be covered by a covering of plastic or rubber 5 that makes the nose pad even more comfortable when placed on the nose of the user.

In a second embodiment, illustrated in FIGS. 7-11, the accommodation (coupling) seat of the nose pad 3, indicated by the reference numeral 12, is constituted by a frame portion that is thinner than the remaining part 13 of the frame 1.

In this embodiment, the nose pad 3 has a distal portion 3a, adapted to be joined to the frame, which is provided in such a way as to embrace the frame portion 12 with reduced thickness and to be closed at least partially around this, in order to then be soldered to the frame.

In this case, the frame is made of metal, as is the nose pad, and therefore the soldering is metal-to-metal.

In practice it has been found that the frame for eyeglasses according to the present invention fully achieves the set aim and objects, in that it makes it possible to have a pair of nose pads that are, on the one hand, extremely comfortable and, on the other hand, substantially concealed behind the thickness of the frame itself.

The frame for eyeglasses thus conceived is susceptible of numerous modifications and variations, all of which are within the scope of the appended claims.

Moreover, all the details may be substituted by other, technically equivalent elements.

In practice, the materials used, as well as the contingent shapes and dimensions, may be any according to the requirements and to the state of the art.

The disclosures in Italian Patent Application No. 102022000012086 from which this application claims priority are incorporated herein by reference.

Where the technical features mentioned in any claim are followed by reference numerals and/or signs, those reference numerals and/or signs have been included for the sole purpose of increasing the intelligibility of the claims and accordingly, such reference numerals and/or signs do not have any limiting effect on the interpretation of each element identified by way of example by such reference numerals and/or signs.

1-12. (canceled)

13. A frame for eyeglasses with nose pads, which comprises frame portions adapted to accommodate a pair of lenses, wherein each frame portion adapted to accommodate a respective lens is provided with a seat which is adapted to accommodate a nose pad.

14. The frame according to claim 13, wherein said seat is adapted to accommodate a distal end portion of said nose pad so that said distal end portion is level with a frame part that surrounds said seat.

15. The frame according to claim 13, wherein said seat of said frame has a thickness that decreases from a bottom upward, i.e., toward a bridge of the frame.

16. The frame according to claim 13, wherein said seat is constituted by a frame portion that is thinner than a remaining part of the frame.

17. The frame according to claim 16, wherein a distal portion of said nose pad, adapted to be coupled to the frame, is provided in such a way as to embrace the frame portion with reduced thickness and to be closed at least partially around this, in order to then be soldered.

18. The frame according to claim 13, wherein said nose pad is made of intrinsically elastic metallic material.

19. The frame according to claim 14, wherein said distal end portion of said nose pad, adapted to be accommodated in said seat of the frame, is shaped so as to be complementary to said seat.

20. The frame according to claim 13, wherein said nose pad has a rod-like, curved shape that substantially reproduces a curvature of the frame portion that accommodates the lens.

21. The frame according to claim 13, wherein said distal end portion of said nose pad, adapted to be accommodated in said seat, is soldered in said seat of the frame.

22. The frame according to claim 13, further comprising a covering made of plastic material or rubber, which is adapted to be fitted on said nose pad in order to improve user comfort.

23. The frame according to claim 13, wherein the nose pads coupled in said respective seats of said frame are substantially hidden behind a thickness of the frame, when the frame is viewed from the front.

24. The frame according to claim 15, wherein said nose pads extend upward from below, i.e., toward the bridge of the frame.
